(19) United States
(12) Patent Application Publication
(10) Pub. No.: US 2023/0335785 A1
(43) Pub. Date: Oct. 19, 2023

(54) HIGH-CONCENTRATION LITHIUM-ION ELECTROLYTES FOR BATTERY CELLS

(71) Applicant: APPLE INC., Cupertino, CA (US)

(72) Inventors: Woo Cheol Shin, Campbell, CA (US); Sang Young Yoon, San Jose, CA (US); Hungoo Cho, San Jose, CA (US)

(73) Assignee: APPLE INC., Cupertino, CA (US)

(21) Appl. No.: 17/659,611

(22) Filed: Apr. 18, 2022

(51) Int. Cl. H01M 10/056; H01M 10/052

(52) U.S. Cl. CPC H01M 10/056; H01M 10/052; H01M 2300/0034; H01M 2300/0037

(57) ABSTRACT

Electrolytes for lithium-containing battery cells are described. The electrolytes may include a solvent that includes at least one non-carbonate-containing ester compound. The electrolytes may further include one or more lithium salts, where the lithium salts have a concentration of greater than or about 2 mols/liter in the electrolyte. The electrolytes may still further include a diluent that includes an aromatic fluorocarbon.

### TECHNICAL FIELD

The present technology relates to electrolytes incorporated into secondary battery cells. More specifically, the present technology relates to electrolytes characterized by a high concentration of lithium ions that are incorporated into lithium-ion secondary battery cells.

### BACKGROUND

Conventional electrolytes for lithium-ion battery cells typically include an inorganic lithium salt, often lithium hexafluorophosphate, concentrated to 1-2 moles/liter in a carbonate solvent. These conventional electrolytes have been in use for years due to their relatively inexpensive components and the predictability of their performance. However, these conventional electrolytes have a number of shortcomings that are increasingly difficult to ignore with the proliferation of battery-powered electronic devices that require economical, safe electric power over a high number of recharging cycles. These shortcomings include the release of gases such as carbon dioxide and volatile organic compounds that can swell the battery cell and, in worst-case scenarios, lead to fires and explosions. Thus, efforts are underway to develop electrolytes for lithium-ion battery cells that have a significantly reduced volatility and flammability compared to conventional electrolytes.

One approach to reducing the volatility and flammability of the electrolyte is to concentrate the lithium salt in the electrolyte above the conventional 1-2 mole/liter range. As shown in FIG. 1, the lithium salt concentrations in conventional electrolytes leave a lot of excess free solvent available to volatilize and react with other battery components such as the battery cell's electrodes. In contrast, when the lithium salt is more concentrated in the electrolyte, there are fewer free solvent molecules present because more are tied up in solvent aggregates with the ions of the lithium salt as shown in FIG. 2. Because aggregated solvent is much less likely than free solvent to volatilize and react with other battery components, concentrated electrolytes are less volatile and less flammable than less-concentrated, conventional electrolytes.

Unfortunately, concentrated electrolytes have their own shortcomings that need to be addressed before they can be adopted on a commercial scale. These shortcomings include the increased cost of the electrolyte when the amount of lithium salts needed are greatly in excess of what is required for conventional electrolytes. They also include the decrease in lithium-ion conductivity caused by the increase in viscosity that occurs when the salt becomes more concentrated in the electrolyte. The lower conductivity of the electrolyte increases the electrical resistance of the battery cell, which in turn increases the cell's internal electrical resistance and reduces the cell's rate capability. These and other shortcomings of concentrated electrolytes have to be addressed before they can be adopted on a commercial scale to provide safe, long-lasting lithium-ion battery cells for electronic devices and other applications.

### BRIEF SUMMARY

Embodiments of the present technology include electrolytes for a lithium-containing battery cell. The electrolytes include a solvent that includes at least one non-carbonate-containing ester compound. The electrolytes further include one or more lithium salts, where the lithium salts have a concentration of greater than or about 2 mols/liter in the electrolyte. The electrolytes further include a diluent that includes a fluorinated organic compound.

In additional embodiments, the one or more lithium salts in the electrolytes may be characterized by a supersaturated concentration in the solvent. In further embodiments, the at least one non-carbonate-containing ester compound may include at least one of an alkyl propionate and an alkyl butyrate. In still further embodiments, the alkyl propionate may include ethyl propionate, propyl propionate, or butyl propionate, and the alkyl butyrate may include ethyl butyrate, propyl butyrate, or butyl butyrate. In yet additional embodiments, the one or more lithium salts may include one or more of LiPF₆, LiAsF₆, LiBF₄, LiSbF₆, LiAlCl₄, LiClO₄, LiBrO₄, LiIO₄, LiCF₃SO₃, LiC₄F₉SO₃, LiCF₃COO, LiN(CF₃CO)₂, LiN(CF₃SO₂)₂, LiN(C₂F₅SO₂)₂, LiN(CF₃SO₂)(C₄F₉SO₂), LiC(CF₃SO₂)₃, LiN(SO₂F)₂, LiPF₄(CF₃), LiPF₄(C₂F₅), LiPF₄(CF₃SO₂)₂, LiPF₄(C₂F₅SO₂)₂, and LiBF₂(C₂F₅SO₂)₂. In yet further embodiments, the electrolytes may be characterized by a viscosity of less than or about 20 cP at 23° C. In still additional embodiments, the diluent represents greater than 10 vol. % of the electrolytes. In more embodiments, the electrolytes further include a phosphorous-containing additive that represents less than or about 2 wt. % of the electrolyte. In still more embodiments, the phosphorous-containing additive may have the formula:

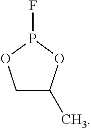

Embodiments of the present technology include further electrolytes that may be included in a lithium-containing battery cell. The electrolytes include a solvent that includes at least one non-carbonate-containing ester compound. The electrolytes further include one or more lithium salts, where the concentration of the lithium salts in the electrolytes are greater than or about 2 mols/liter. The electrolytes still further include a diluent that includes a fluorinated organic compound. The electrolytes yet further include a phosphorous-containing additive that represents less than or about 2 wt. % of the electrolytes. The electrolytes are characterized by a viscosity of less than or about 20 cP at 23° C.

In additional embodiments, the at least one non-carbonate-containing ester compound may include at least one of an alkyl propionate and an alkyl butyrate. In further embodiments, the one or more lithium salts in the electrolytes may include one or more of LiPF₆, LiAsF₆, LiBF₄, LiSbF₆, LiAlCl₄, LiClO₄, LiBrO₄, LiIO₄, LiCF₃SO₃, LiC₄F₉SO₃, LiCF₃COO, LiN(CF₃CO)₂, LiN(CF₃SO₂)₂, LiN(C₂F₅SO₂)₂, LiN(CF₃SO₂)(C₄F₉SO₂), LiC(CF₃SO₂)₃, LiN(SO₂F)₂, LiPF₄(CF₃), LiPF₄(C₂F₅), LiPF₄(CF₃SO₂)₂, LiPF₄(C₂F₅SO₂)₂, and LiBF₂(C₂F₅SO₂)₂. In yet additional embodiments, the phosphorous-containing additive may have the formula:

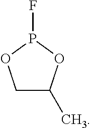

In more embodiments, the electrolytes may include less than or about 5 wt. % of carbonate-containing compounds.

Embodiments of the present technology still further include lithium-containing battery cells. The battery cells include a positive electrode, a negative electrode, and a lithium-containing electrolyte. The lithium-containing electrolyte includes a solvent that includes at least one non-carbonate-containing ester compound. The electrolyte further includes at least one lithium salt having a concentration of greater than or about 2 mols/liter, and a diluent that includes a fluorinated organic compound.

In additional embodiments, the at least one non-carbonate-containing ester compound may include at least one of an alkyl propionate and an alkyl butyrate. In further embodiments, the lithium-containing electrolyte may be characterized by a viscosity of less than or about 20 cP at 23° C. In still further embodiments, the lithium-containing electrolyte may include a phosphorous-containing additive that represents less than or about 2 wt. % of the lithium-containing electrolyte. In yet additional embodiments, the lithium-containing battery cell is characterized by a swelling volume percentage of less than or about 10 vol. % after operating at 85° C. for 8 hours. In more embodiments, the battery cell may be characterized by a change in battery cell impedance of less than or about 40% after greater than or about 600 charging cycles.

Embodiments of the present technology include battery cell electrolytes that are highly concentrated in lithium ions to lower the battery cell's electrical impedance (Rₛₛ) and reduce the growth of the battery cell's Rₛₛ over many charging cycles. In embodiments, the electrolyte includes a combination of solvent and diluent that permits the electrolyte to hold a high concentration of lithium ions without a substantial increase in the electrolyte's viscosity that can slow the transport of the lithium ions through the electrolyte. The combination of solvent and diluent also reduces the amount of free solvent in the electrolyte that can trigger side reactions and cause swelling in the battery cell. In further embodiments, the electrolyte includes a phosphorous-containing additive that keeps the electrolyte stable over many more charging cycles than an electrolyte formulated without the additive. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a simplified schematic of free solvent and solvated ions from a lithium salt in a conventional electrolyte.

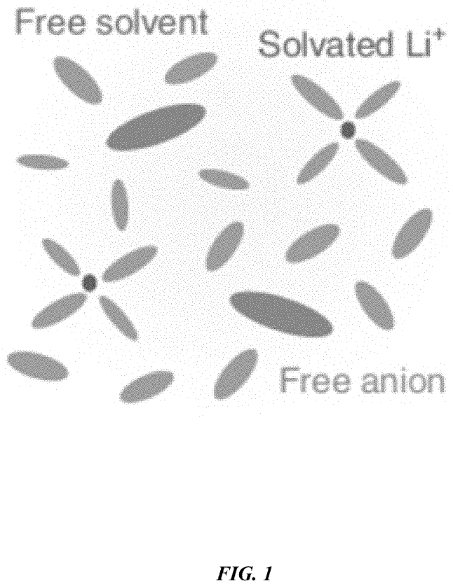

FIG. 2 shows a simplified schematic of solvent-ion aggregates in an electrolyte having a concentrated lithium-containing salt.

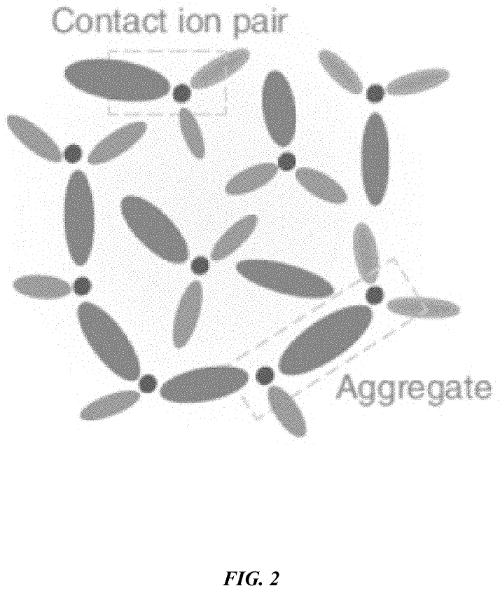

FIG. 3 shows a simplified schematic of dispersed solvent-ion aggregates surrounded by diluent in a diluted concentrated electrolyte according to present embodiments.

FIG. 4 shows a battery cell in accordance with present embodiments.

FIG. 5 shows the placement of a battery cell in a computer system in accordance with present embodiments.

FIG. 6 shows a battery cell in a portable electronic device in accordance with present embodiments.

FIG. 7 is a graph of battery cell swelling as a function of a molar ratio of lithium salts to solvent in the electrolyte for a group of lithium-ion battery cells.

FIG. 8 is a graph of capacity retention as a function of cycle life for a group of lithium-ion battery cells with various electrolyte formulations.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Rechargeable lithium-ion battery cells include an electrolyte to transport lithium ions between the electrodes of the battery cell. When the battery cell discharges, lithium ions are released from the negative electrode (anode) and move through the electrolyte to the positive electrode (cathode) while electric current, which has the opposite electric charge, moves in the same direction through an external conductor to power an electronic device. Charging the battery cell reverses the flow of lithium ions in the electrolyte so they return to the anode from the cathode while an external source of electric power applied to the battery cell causes electric current to flow in the same, reverse direction.

High-quality rechargeable battery cells are characterized by a low electrical impedance (Rₛₛ) during the charge and discharge cycles of the battery cell. A low Rₛₛ permits the battery cell to channel most of the electrical energy stored and released by the cell into useful work powering a device. A low Rₛₛ converts less of the electrical energy into wasted heat that raises the temperature of the battery cell, sometimes to levels that can damage or destroy the cell. A high-quality lithium-ion battery cell with a low electrical impedance (Rₛₛ) includes an electrolyte that can efficiently transport the lithium ions between the electrodes of the cell. In many instances, the electrolyte includes an organic liquid solvent in which the lithium ions exist as dissolved lithium salts. The flow rate of the lithium ions through the organic liquid solvent can have a direct effect on the Rₛₛ of the battery cell.

Several characteristics of the electrolyte affect the rate of transport of lithium ions through the electrolyte. These include the concentration of the lithium ions in the electrolyte and the viscosity of the electrolyte. Unfortunately, these electrolyte characteristics are at cross purposes in conventional electrolytes that include lithium salts dissolved in organic liquid solvents: higher concentrations of the lithium salts increase the transport rate but also increase the electrolyte's viscosity, which decreases the lithium-ion transport rate. Higher concentrations of the lithium salts also reduce the amount of free solvent molecules in the electrolyte that can volatilize to cause the battery cell to swell in volume, and in some cases to rupture.

Embodiments of the present technology address these and other problems with conventional electrolytes by providing new electrolyte formulations that combine higher concentrations of lithium salts and low electrolyte viscosities. In embodiments, the electrolyte formulations can include lithium ion concentrations of greater than or about 2 mols/liter and viscosities of less than or about 20 cP at room temperature (e.g., about 23° C.). The high-Li⁺-concentration, low viscosity electrolytes contribute to a high-quality rechargeable lithium-ion battery cell characterized by a low Rₛₛ that undergoes a substantially smaller increase in Rₛₛ over hundreds of charge-discharge cycles.

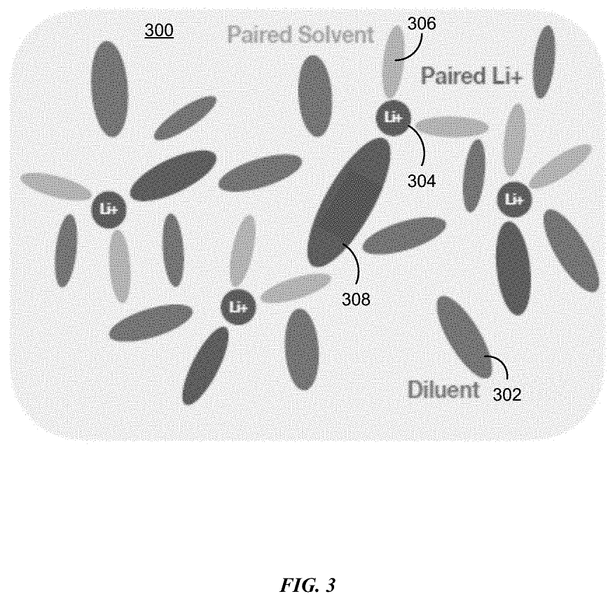

Embodiments of the present electrolytes achieve these electrolyte characteristics by combining a non-carbonate-containing ester compound solvent with a diluent that includes one or more aromatic fluorocarbons. In embodiments, the combination of solvent and diluent permits the dissolving of one or more lithium salts into the electrolyte at concentrations of greater than or about 4 mols/liter or more. In further embodiments, the concentration of lithium salts in the electrolyte exceeds the saturation point of the salts in the solvent alone and creates regions in the electrolyte where the lithium salts have a supersaturated concentration in the solvent. FIG. 3 shows a simplified schematic of components of an electrolyte 300 that include a diluent 302 that disperses concentrated lithium ions 304 in a solvent into localized regions of highly concentrated lithium ions 304 throughout the electrolyte 300. The high concentrations of lithium ions 304 in these localized regions integrates the surrounding paired solvent molecules 306 into coordination complexes, and significantly reduces the amount of free solvent molecules 308 in the electrolyte 300. The reduction in free solvent reduces the overall vapor pressure of the electrolyte, which reduces problems with solvent volatility such as outgassing, battery cell bulging, and fire and explosion hazards in the case of flammable organic solvents. In addition, the combination of solvent and diluent permits the high concentration of the lithium salts without substantially increasing the viscosity of the electrolyte above, for example, 20 cP at room temperature.

Embodiments of the present technology also include battery cells that incorporate the present electrolytes. Exemplary battery cells include non-rechargeable, primary battery cells and rechargeable, secondary battery cells. Exemplary battery cells may include a positive electrode (e.g., a cathode), a negative electrode (e.g., an anode), and the diluted concentrated electrolyte. Specific examples of battery cells include lithium-containing battery cells (e.g., lithium-ion battery cells, lithium-metal battery cells, etc.) having a positive electrode that includes lithium metal or a lithium-containing compound, and a negative electrode that includes at least one of carbon (e.g., graphite), silicon, or a lithium-transition metal oxide (e.g., lithium titanium oxide). Exemplary lithium-containing battery cells have may have one or more enhancements over conventional lithium-ion battery cells that use electrolytes with conventional concentrations of lithium salts (e.g., less than 2 mols/liter). These enhancements may include increased rate capability for the battery cell, increased cycle life for the battery cell, and increased safety for the battery cell, among other enhancements.

### Exemplary Electrolytes

Embodiments of the present electrolytes include one or more lithium salts incorporated into a liquid medium. In additional embodiments, the liquid medium includes a solvent having at least one non-carbonate-containing ester compound, and a diluent that includes at least one aromatic fluorocarbon. In further embodiments, the electrolytes may include a phosphorous-containing additive that extends the capacity retention and reduces the growth rate of the battery cell's impedance over an extended number of charge/discharge cycles. In more embodiments, the electrolytes may include other additives such as negative-electrode additives, positive-electrode additives, redox additives, and flame retardant additives, among other additional additives.

In embodiments, the one or more lithium salts may include one or more lithium fluorosulfonyl imide salts. In additional embodiments, the lithium fluorosulfonyl imide salts may include lithium bis(fluorosulfonyl) imide (LiFSI), lithium bis(trifluoromethanesulfonyl) imide (LiTFSI), lithium bis(pentafluoroethanesulfonyl) imide (LiBETI), among other lithium fluorosulfonyl imide salts. In further embodiments, the lithium salts may include one or more lithium borate salts, such as lithium bis(oxalate)borate (LiBOB), and lithium tetrafluoroborate (LiBF₄), among others. In more embodiments, the lithium salts may include one or mor einorganic lithium fluoride salts such as lithium hexafluorophosphate (LiPF₆), lithium hexafluoroarsenate (LiAsF₆), and lithium tetrafluoroborate (LiBF₄), among others. In yet more embodiments, the lithium salts may include lithium sulfate, sulfite, and sulfonate salts such as lithium sulfate (Li₂SO₄), lithium sulfite (Li₂SO₃), and lithium trifluoromethanesulfonate (LiCF₃SO₃), among others. In still further embodiments, the lithium salts may include lithium nitrates, nitrites, and thiocyanates such as lithium nitrate (LiNO₃), lithium nitrite (LiNO₂), and lithium thiocyanate (LiSCN), among others. In yet additional embodiments, the lithium salts may include lithium halogens and oxyhalogens such as lithium fluoride (LiF), lithium chloride (LiCl), lithium bromide (LiBr), lithium iodide (LiI), and lithium perchlorate (LiClO₄), among others.

In embodiments, the lithium salts may have a concentration in the electrolyte of greater than or about 2 mols/liter, greater than or about 3 mols/liter, greater than or about 4 mols/liter, greater than or about 5 mols/liter, greater than or about 6 mols/liter, greater than or about 7 mols/liter, greater than or about 8 mols/liter, greater than or about 9 mols/liter, greater than or about 10 mols/liter, greater than or about 11 mols/liter, greater than or about 12 mols/liter, greater than or about 13 mols/liter, greater than or about 14 mols/liter, greater than or about 15 mols/liter, or more. In additional embodiments, the lithium salts may be supersaturated in the electrolyte's solvent and may have a molar concentration that exceeds the conventional saturation concentration for the lithium salts in the solvent at the temperature of the electrolyte. In further embodiments, the lithium salts may be supersaturated in the solvent at a first, lower temperature of the electrolyte and may be saturated, or unsaturated, at a second, higher temperature of the electrolyte. In more embodiments, the first and second temperatures may be within the range of operating temperatures for a battery cell that includes the electrolyte.

In additional embodiments, the concentration of the lithium salts may be selected to minimize the number of free solvent molecules present in the electrolyte. In further embodiments, the lithium salt concentration may be selected to provide a molar ratio with the solvent molecules that incorporates substantially all the solvent molecules into solvent-solute complexes. In more embodiments, the molar ratio of the lithium salts to the solvent molecules may be about 1:1. In other embodiments, the molar ratio of the lithium salts to the solvent molecules may be greater than or about 1:10, greater than or about 1:5, greater than or about 1:2.5, greater than or about 1:1, greater than or about 1.1:1, greater than or about 1.5:1, greater than or about 2:1, greater than or about 3:1, greater than or about 4:1, greater than or about 5:1, greater than or about 6:1, greater than or about 7:1, greater than or about 8:1, greater than or about 9:1, greater than or about 10:1, or more.

In embodiments, the non-carbonate-containing ester compounds may include ester compounds that lack a carbonate (—CO₃) group. In further embodiments, the non-carbonate-containing ester compound may include an esterification product of a C₁-to-C₆ alcohol and propionic acid. These alkyl propionate reaction products may include methyl propionate, ethyl propionate, propyl propionate, butyl propionate, pentyl propionate, and hexyl propionate, among other alkyl propionate reaction products. In still further embodiments, the non-carbonate-containing ester compounds may include an esterification product of a C₁-to-C₆ alcohol and butyric acid. These alkyl butyrate reaction products may include methyl butyrate, ethyl butyrate, propyl butyrate, butyl butyrate, pentyl butyrate, and hexyl butyrate, among other alkyl butyrate reaction products. In more embodiments, the solvent may be free of carbonate-containing compounds. In yet additional embodiments, the solvent is free of carbonate-containing compounds such as ethylene carbonate (EC), vinylene carbonate (VC), propylene carbonate (PC), dimethyl carbonate (DMC), ethyl methyl carbonate (EMC), diethyl carbonate (DEC), methyl acetate (MA), and methyl propionate (MP), among other carbonate-containing compounds. In yet further embodiments, the solvent is free of fluorinated carbonate compounds such as monofluoroethylene carbonate (MFEC), difluoroethylene carbonate (DFEC), monfluoromethyl difluoromethyl carbonate (F-DMC), and trifluorodimethyl carbonate (TFDMC). In still more embodiments, the electrolyte may be free of carbonate-containing compounds.

In some embodiments, the electrolyte may be free of carbonate-containing compounds. In additional embodiments, the electrolyte may contain one or more carbonate-containing compounds that function as additional additives in the electrolyte. In embodiments, the carbonate-containing compounds may represent an amount of the electrolyte that is less than or about 5 wt. %, less than or about 4 wt. %, less than or about 3 wt. %, less than or about 2 wt. %, less than or about 1 wt. %, or less.

In embodiments, the diluent may include at least one fluorinated organic compound having one or more substituted fluorine groups. In further embodiments, these fluorinated organic compounds may include fluorinated hydrocarbons, fluorinated aromatic compounds, hydrofluoroether compounds, and fluorinated orthoformate compounds, among other fluorinated organic compounds. In still further embodiments, fluorinated hydrocarbons may include fluorinated linear alkanes having the formula CₙHₓF_{y}, where n=1 to 20, x=0 to 2n+1, y=1 to 2n+2, and x+y=2n+2; fluorinated cycloalkanes having at least one fluorine group; fluorinated alkenes having at least one carbon-carbon double bond and at least one fluorine group; and fluorinated alkynes having at least one carbon-carbon triple bond and at least one fluorine group; among other fluorinated hydrocarbons.

In more embodiments, fluorinated aromatic compounds may include fluorinated benzene compounds having the formula:

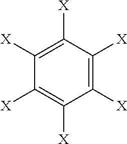

where each X is independently a hydrogen group or a fluorine group, and at least one X is a fluorine group. In embodiments, fluorinated aromatic compounds may include 1-fluoro-benzene, 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluoro benzene, 1,2,4,5-tetrafluorobenzene, pentafluorobenzene, and hexafluorobenzene. In more embodiments, fluorinated aromatic compounds may include fluorinated toluene compounds having the formula:

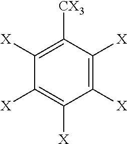

where each X is independently a hydrogen group or a fluorine group, and at least one X is a fluorine group. In still more embodiments, the fluorinated toluene compounds may include 1-fluorotoluene (benzomonofluoride), 2-fluorotoluene, 3-fluorotoluene, 4-fluorotoluene, 1,1-difluorotoluene (benzodifluoride), 2,3-difluorotoluene, 2,4-difluorotoluene, 2,5-difluorotoluene, 2,6-difluorotoluene, 1,1,1-trifluorotoluene (benzotrifluoride), 2,3,4-trifluorotoluene, 2,3,5-trifluorotoluene, 2,3,6-trifluorotoluene, and 2,3,4,5-tetrafluorotoluene, among other fluorinated toluene compounds.

In additional embodiments, the fluorinated aromatic compounds may include fluorinated phenyl compounds having the formula:

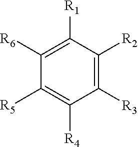

where R₁-R₆ are each independently, a hydrogen group, a fluorine group, a non-fluorinated C₁-C₆ alkyl group, or a fluorinated C₁-C₆ alkyl group, wherein at least one of R₁-R₆ includes a fluorine group.

In yet additional embodiments, the fluorinated aromatic compounds may include fluorinated polyphenolic compounds and fluorinated polycyclic aromatic compounds. In embodiments, the fluorinated polyphenolic compounds may include fluorinated biphenyl compounds having the formula:

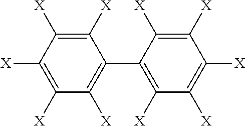

where each X is independently a hydrogen group or a fluorine group, and at least one X is a fluorine group. Embodiments of fluorinated polyphenolic compounds further include one or more X groups representing a non-fluorinated or fluorinated alkyl group. In further embodiments, the one or more X groups may represent a fluorinated or non-fluorinated methyl, ethyl, propyl, butyl, pentyl, or hexyl group. Specific examples of fluorinated polycyclic aromatic compounds include fluorinated naphthalene compounds, fluorinated anthracene compounds, and fluorinated phenantherene compounds having the formulas:

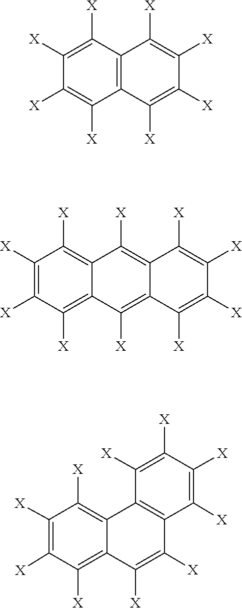

where each X is independently a hydrogen group or a fluorine group, and at least one X is a fluorine group. In still further embodiments, the fluorinated polycyclic aromatic compounds may include one or more X groups representing a non-fluorinated or fluorinated alkyl group. In more embodiments, the one or more X groups may represent a fluorinated or non-fluorinated methyl, ethyl, propyl, butyl, pentyl, or hexyl group.

In embodiments, the hydrofluoroether compounds may include 1,1,2,2-tetrafluoroethyl-2,2,3,3-tetrafluoropropyl ether (HFE), bis(2,2,2-trifluoroethyl) ether (BTFE), 1,1,2,2-tetrafluorethyl-2,2,2-trifluoroethyl ether (TFTFE), methoxynonafluorobutane (MOFB), and ethyoxynonafluorobutane (EOFB), among hydrofluoroether compounds. Exemplary fluorinated orthoformate compounds include tris(2,2,2-trifluoroethyl)orthoformate (TFEO), tris(hexafluoroisopropyl)orthoformate (THFiPO), tris(2,2,-difluoroethyl)orthoformane (TDFEO), bis(2,2,2-trifluoroethyl)methyl orthoformate (BTFEMO), tris(2,2,3,3,3-pentafluoropropyl)orthoformate (TPFPO), and tris(2,2,3,3-tetrafluoropropyl)orthoformate (TTPO), among other fluorinated orthoformate compounds.

In embodiments, the diluent may provide one or more of the following characteristics to the electrolyte: (i) lowering the viscosity of the electrolyte, (ii) lowering the cost of the electrolyte, (iii) providing increased permittivity and coordination properties to make a highly soluble dispersion in the electrolyte of lithium salts and solvent while not changing the local coordinating environment of the electrolyte, (iv) providing increased inertness and stability to not compromise the electrochemical window of the electrolyte, and (v) reducing the flammability and volatility of the electrolyte to increase the safe operation of the battery cell.

In additional embodiments, the diluent differs from the solvent in its ability to dissolve the lithium salts in the electrolyte. In further embodiments, the ability of the electrolyte to dissolve the lithium salts into their constituent ions is correlated to the polarity of the dissolving medium, as measured by the dielectric constant of the dissolving medium. In embodiments, the diluent may have a dielectric constant that is lower than the dielectric constant of the solvent. In more embodiments, the dielectric constant for the diluent may be less than or about 0.5 times the dielectric constant of the solvent. In additional embodiments, the dielectric constant of the diluent relative to the solvent may be less than or about 0.25 times, less than or about 0.1 times, less than or about 0.05 times, less than or about 0.01, or less. In yet further embodiments, the diluent may have a dielectric constant (F) at 25° C. of less than or about 10, less than or about 7.5, less than or about 5, less than or about 2.5, less than or about 1, or less.

In more embodiments, the diluent may be characterized by a poor solubility, or no substantial solubility, of the lithium salts compared to the solvent. In embodiments, the diluent may be characterized by a solubility for the lithium salts that is at least 10 times lower than the solvent, at least 15 times lower, at least 20 times lower, at least 25 times lower, at least 30 times lower, at least 35 times lower, at least 40 times lower, or at least 50 times lower, or lower. For a diluent that has a solubility at least 10 times lower than the solvent, a salt having a 10M solubility in the solvent cannot have a solubility greater than 1M in the diluent. Similarly, for a diluent that has a solubility at least 25 times lower than the solvent, a salt having a 10M solubility in the solvent cannot have a solubility greater than 0.25M in the diluent. In further embodiments, a diluent may have minimal disruption on the solvation structure of the salt-solvent aggregates (e.g., solvation complexes). In still further embodiments, the diluent may be selected that have no significant coordination or associate between the diluent molecules and the ions (e.g., cations) of the lithium-containing active salt, and the ions remain associated almost exclusively with the solvent molecules.

In still more embodiments, the electrolyte may be characterized by a volume percentage of the diluent that is greater than or about 10 vol. % of the electrolyte, greater than or about 20 vol. %, greater than or about 30 vol. %, greater than or about 40 vol. %, greater than or about 50 vol. %, greater than or about 60 vol. %, greater than or about 70 vol. %, greater than or about 80 vol. %, greater than or about 90 vol. %, or more. In yet additional embodiment, the electrolyte may be characterized by a volume percentage of solvent that is less than or about 90 vol. % of the electrolyte, less than or about 80 vol. %, less than or about 70 vol. %, less than or about 60 vol. %, less than or about 50 vol. %, less than or about 40 vol. %, less than or about 30 vol. %, less than or about 20 vol. %, less than or about 10 vol. %, or less.

In embodiments, the solvent may be present in an amount that incorporates substantially all the solvent molecules into solvent-solute complexes with the lithium salts of the electrolyte. In additional embodiments, the majority of the solvent molecules (as a mole percentage of the total number of solvent molecules present in the electrolyte) may be associated (e.g., solvated or coordinated) with the ions of the lithium salts (e.g., the salt cations) at a mole percentage of greater than or about 80 mol. %, greater than or about 85 mol. %, greater than or about 90 mol. %, greater than or about 95 mol. %, greater than or about 96 mol. %, greater than or about 97 mol. %, greater than or about 98 mol. %, greater than or about 99 mol. %, or more. Because the majority of solvent molecules are associated with the ions of the lithium salts, the mole percentage of free solvent molecules in the electrolyte may be less than or about 20 mol. %, less than or about 15 mol %, less than or about 10 mol. %, less than or about 5 mol. %, less than or about 4 mol. %, less than or about 3 mol. %, less than or about 2 mol. %, less than or about 1 mol. %, or less.

In embodiments, the diluent reduces the viscosity of the electrolyte compared to the viscosity of the concentrated solution of the lithium salts in the diluent-free solvent. In additional embodiments, the electrolyte may be characterized by a room temperature (e.g., 23° C.) viscosity of less than or about 50 centipoise (cP), less than or about 40 cP, less than or about 30 cP, less than or about 20 cP, less than or about 10 cP, less than or about 5 cP, less than or about 2.5 cP, less than or about 1 cP, or less.

In further embodiments, the diluent and solvent in the electrolyte may interact to disperse the lithium salts throughout the electrolyte without substantially lowering the molar concentration of the lithium salts in the solvent. In more embodiments, the diluent may disperse localized regions of highly concentrated lithium salts in the solvent throughout the electrolyte. In still more embodiments, the electrolyte may be characterized by a molar ratio of the solvent to the diluent that is less than or about 10:1, less than or about 7.5:1, less than or about 5:1, less than or about 2.5:1, less than or about 1:1, less than or about 1:2.5, less than or about 1:5, less than or about 1:7.5, less than or about 1:10, or less. In yet additional embodiments, the electrolyte may be characterized by a volume ratio of the solvent to the diluent that is less than or about 10:1, less than or about 7.5:1, less than or about 5:1, less than or about 2.5:1, less than or about 1:1, less than or about 1:2.5, less than or about 1:5, less than or about 1:7.5, less than or about 1:10, or less.

In further embodiments, the diluent can reduce the overall concentration of the lithium salts in the electrolyte. In embodiments, the diluent may reduce the molar concentration of the lithium salts in the electrolyte by greater than or about 20%, greater than or about 25%, greater than or about 30%, greater than or about 35%, greater than or 40%, greater than or 50%, greater than or about 60%, greater than or about 70%, or more, compared to a molar concentration of the lithium salts in a diluent-free solvent. Because the dissolved lithium salts are more coordinated with the solvent than the diluent, several characteristics of the electrolyte more closely correspond to the concentrated salt in the solvent without the diluent. For example, the electrolyte may be characterized by an ionic conductivity, wettability, and/or solid electrolyte interphase (SEI) layer formation ability that are the same as the concentrated lithium salts in the diluent-free solvent.

In embodiments, the electrolyte may further include a phosphorous-containing additive that extends the capacity retention and reduces the growth rate of the battery cell's impedance over an extended number of charge/discharge cycles. In additional embodiments, the phosphorous-containing additive may include an organo-phosphorous compound that includes one or more organic carbon groups in addition to at least one phosphorous atom. In further embodiments, the organo-phosphorous compound may further include one or more oxygen atoms. In still further embodiments, the organo-phosphorous compound may further include one or more fluorine atoms. In yet more embodiments, the organo-phosphorous compound may include a heterocyclic ring structure. In embodiments the phosphorous-containing additive may have the formula:

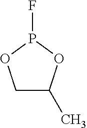

In additional embodiments, the phosphorous-containing additive may be included in the electrolyte in an amount that is less than or about 5 wt. % of the electrolyte, less than or about 4 wt. %, less than or about 3 wt. %, less than or about 2 wt. %, less than or about 1 wt. %, or less.

In more embodiments, the electrolyte may include one or more additional additives. In still more embodiments, the additional additives may include negative-electrode additives, positive-electrode additives, redox additives, and flame retardant additives, among other types of additives. In further embodiments, the electrolyte may include each of the additional additives in an amount of less than or about 10 wt. %, less than or about 7.5 wt. %, less than or about 5 wt. %, less than or about 4 wt. %, less than or about 3 wt. %, less than or about 2 wt. %, less than or about 1 wt. %, less than or about 0.5 wt. %, less than or about 0.25 wt. %, less than or about 0.1 wt. %, less than or about 0.05 wt. %, less than or about 0.01 wt. %, or less.

In still further embodiments, the negative (anode)-electrode additives may include one or more of ammonium perfluorocaprylate, and vinyl ethylene carbonate, among other negative electrode additives. In yet additional embodiments, the negative-electrode additives may include maleimide compounds such as ortho-maleimide, meta-maleimide, and para-maleimide. They also include glycolide compounds such as glycolide, 3-methyl glycolide, 3,6-dimethyl glycolide, and 3,3,6,6,-tetramethyl glycolide, among other glycolide compounds. Examples also include siloxane compounds such as diethylene glycol methyl-(3-dimethyl(trimethylsiloxy)silyl propyl) ether, diethylene glycol methyl-(3-dimethyl(trimethylsiloxy)silyl propyl)-2-methylpropyl ether, diethylene glycol methyl-(3-bis(trimethylsiloxy)silyl propyl) ether, diethylene glycol-(3-methyl-bis(trimethylsiloxy)silyl-2-methylpropyl) ether, and methyl phenyl bis-methoxydiethoxysilane, among other siloxane compounds. In more embodiments, the negative-electrode additives may include olefinic compounds such as vinyl acetate, divinyl adipate, and allyl methyl carbonate, among others. They may also include sulfur-containing compounds such as ethylene sulfite, propylene sulfite, 1,3-propane sultone, butyl sultone, vinyl ethylene sulfite, prop-1-ene-1,3-sultone, 3-fluoro-1,3-propane sultone, and methylene methanedisulfonate, among other sulfur-containing compounds. They may further include allyl cyanide, acrylic acid nitrile, p-toluenesulfonyl isocyanate, and ethyl isocyanate. They may still further include halogen-containing compounds such as chloro-ethylene carbonate, fluoro-ethylene carbonate, α-bromo-γ-butyrolactone, methyl chloroformate, tetrachloroethylene, and 4-fluorophenyl acetate, among other halogen-containing compounds. In more embodiments, the negative-electrode additives may also include (4R, 5R)-dimethyl-2-oxo-1,3,-dioxolane-4,5-dicarboxylate, 2-vinylpyridine, 1,3-propanediolcyclic sulfate, glutaric anhydride, and 3,9-divinyl-2,4,8,10-tetraoxasprio[5,5]undecane.

In more embodiments, the positive-electrode additives may include polyphenyl compounds such as biphenyl, o-terphenyl, and m-terphenyl, among other polyphenyl compounds. They may also include thiophene compounds such as 2,2′-bithiophene, and 2,2′:5′,2″-terthiophene, among other thiophene compounds. They may further include furan compounds such as furan, 2-methyl furan, and dimethyl furan, among other furan compounds. They may additionally include anisole compounds such as anisole, and thioanisole, among other anisole compounds. They may still further include phosphorous-containing compounds such as triphenyl phosphine, ethyl diphenylphosphinite, tris(pentafluorophenyl)phosphine, and triethyl phosphite, among other phosphorous-containing compounds. They may further include lithium bis-oxalate compounds such as lithium bis(oxalate)borate, lithium difluoro(oxalato)-borate, and lithium tetrafluoro(oxalate) phosphate, among others. They may further include N′,N-dimethyl-aniline, N-(triphenylphosphoranylidene) aniline, N,N′-4,4′-diphenylmethane-bismaleimide, 2,2′-bis[4-[4-maleimidophenoxy)phenyl]propane, adamantyl toluene, tris(pentafluorophenyl)borane, and 3,4-ethylene-dioxythiophene, among other positive-electrode additives. They may yet still further include fluorinated carbonates such as 4-(trifluoromethyl) ethylene carbonate, 4-(perfluorobutyl) ethylene carbonate, 4-(perfluorohexyl) ethylene carbonate, and 4-(perfluorooctyl) ethylene carbonate, among other fluorinated carbonates. They may yet also include trimethoxyboroxine, succino nitrile, tris(trimethylsilyl)phosphite, trimethylene sulfate, triphenylamine, 1,4-benzodiozane-6,7-diol, 1,2,3-dioxathiolane-2,2-dioxide, di-(2,2,2-trifluoroethyl)carbonate, tris(trimethylsilyl)borate, tris(trimethylsilyl)phosphate, 1,3,5-trihydroxybenzene, tetraethoxysilane, N,N-diethylamino trimethylsilane, and trimethyl borate, among other positive-electrode additives.

In embodiments, the redox additives may include 2,5-di-tert-butyl-1,4-dimethoxybenzene, 3,5-di-tert-butyl-1,2,-dimethoxybenzene, 4,6-tert-butyl-1,3-benzodioxole, 5,7-tert-butyl-1,4-benzodioxin, 4-tert-butyl-1,2-dimethoxybenzene, 1,4-di-tert-butyl-2,5-bis(2,2,2-trifluoroethoxybenzene), tetraethyl-2,5-di-tert-butyl-1,4-phenylene diphosphate, dimethoxydiphenylsilane, 1,4-bis[bis(1-methylethyl)phosphinyl]-2,5-dimethoxybenzene, 1,4-bis(trimethylsilyl)-2,5-dimethoxybenzene, 2-(pentafluorophenyl)-tetrafluoro-1,3,2-benzodioxaborole, tris(4-bromophenyl) amine, tris(2,4-dibromophenyl) amine, diphenyl amine, triphenylamine, and ferrocene, among other redox additives. They may also include TEMPO compounds such as 2,2,6,6-tetramethylpiperinyl-oxide, 4-methoxy-TEMPO, 4-cyano-TEMPO, and 3-cyano-2,2,5,5-tetramethyl-1-pyrrolidinyloxy, among other TEMPO compounds. They may further include phenothiazine compounds such as phenothiazine, 10-methyl-phenothiazine, 10-ethylphenothiazine, 3-chloro-10-methylphenothiazine, 10-isopropylphenothiazine, 10-acetylphenothiazine, N-isopropylphenothiazine, N-tert-butylphenothiazine, and N-phenylphenothiazine, among other phenothiazine compounds.

In more embodiments, the flame retardant additives may include organic phosphorous compounds such as dimethyl methylphosphonate, diethylethylphosphonate, triphenyl phosphate, tri-(4-methoxyphenyl) phosphate, cresyl diphenyl phosphate, diphenyloctyl phosphate, bis(2-methoxyethoxy)methylallylphosphonate, triethoxyphsphazen-N-phosphoryldiethylester, (ethoxy)pentafluorocyclotriphosphazene, bis(2,2,2-trifluoroethyl)methylphosphonate, triphenyl phosphite, bis(2,2,2-trifluoroethyl)ethylphosphonate, resorcinol bis(diphenyl phosphate), bis(N,N-diethyl)(2-methoxyethoxy)methylphosphonamidate, ethylene ethyl phosphate, triethyl phosphate, phosphaphenanthrene, and 1-butyl-1-methylpyrroldinium hexafluorophosphate, among other organic phosphorous compounds. They may also include fluorine-containing compounds such as allyl tris(2,2,2-trofluoroethyl)carbonate, and 2,4,6-tris(trifluoromethyl)-1,3,5-triazine, among other fluorine-containing flame retardant compounds.

### Exemplary Effects of Diluted Concentrated Electrolytes on Battery Cell Performance

The above-described diluted concentrated electrolytes can affect many different battery cell performance characteristics including the rate capability of the battery cell, the cycle life of the battery cell, and the internal electrical resistance of the battery cell, among other performance characteristics. The rate capability of the battery cell may be evaluated by comparing the discharge capacity retention, typically measured as a percentage of the battery cell's initial discharge capacity, at two or more different charge and/or discharge rates, typically described as a multiple of the C-Rate. The cycle life of the battery cell may be evaluated by comparing capacity retention over a range of charging and discharging cycles for the battery cell. In some comparisons, the cycle lifetime is expressed as the capacity retention of the battery cell after a fixed number of charge/discharge cycles (e.g., 20 cycles, 50 cycles, 60 cycles, 100 cycles, 200 cycles, 300 cycles, 500 cycles etc.). In additional comparisons, the cycle lifetime is expressed as the cycle number where the capacity decreases to 80% of the initial capacity (e.g., 5 cycles, 20 cycles, 50 cycles, 60 cycles, 100 cycles, 200 cycles, 300 cycles, 500 cycles etc.). The internal electrical resistance of the battery cell may be expressed in milliohms (mΩ). The resistance may be measured at a particular battery temperature (e.g., 25° C., 45° C., etc.) and after a particular number of charge/discharge cycles (e.g., Cy 3, Cy 7, Cy 20, Cy 50, etc.).

In embodiments, the present electrolytes can improve the battery cell's performance characteristics relative to a battery cell that includes a conventional electrolyte with a 1-2 mols/liter concentration of lithium salts. The performance improvements may include increasing at least one of the battery cell's rate capability, cycle life, and/or electrical resistance. For example, a battery cell that includes a diluted concentrated electrolyte may have an increased rate capability of at least 10% relative to a battery cell that has a conventional electrolyte but is otherwise identical. Similarly, a battery cell that includes the diluted concentrated electrolyte may have an increased cycle life of at least 10% relative to a battery cell that has a conventional electrolyte but is otherwise identical.

In embodiments, the present electrolytes can improve (e.g., increase) one or more of the battery cell's performance characteristics by at least 11%, 12%, 13%, 14%, 15%, 16% 17%, 18%, 19%, 20%, 21%, 22%, 23%, 24%, 25%, 30%, 35%, 40%, 45%, 50%, 55%, 60%, 65%, 70%, 80%, and 90%, among other threshold levels. Additional ranges include 10% to 100%, 15% to 90%, 20% to 80%, and 30% to 50%, among other exemplary ranges.

### Exemplary Battery Cells

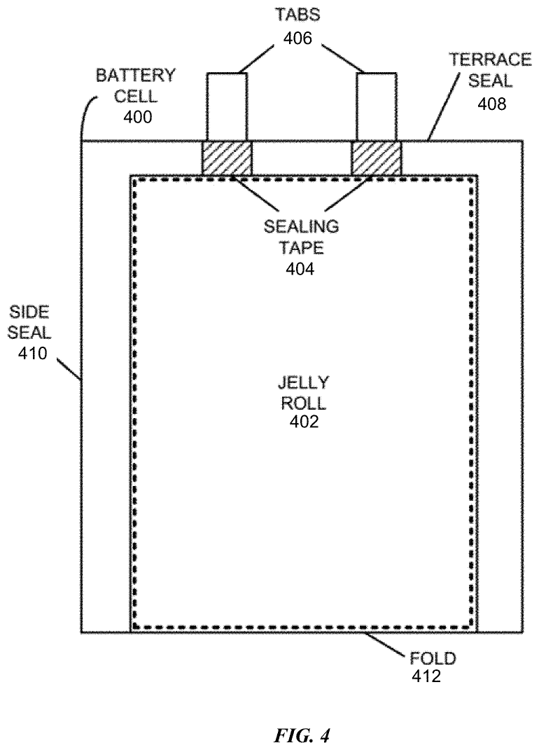

FIG. 4 shows a battery cell 400 in accordance with embodiments of the present battery cells that include a diluted concentrated electrolyte. The battery cell 400 may correspond to a lithium-ion battery cell that is used to power a portable electronic device. Battery cell 400 includes a jelly roll 402 containing a number of layers which are wound together, including a positive electrode (a.k.a., cathode) with an active coating, a separator, and a negative electrode (a.k.a., anode) with an active coating. The diluted concentrated electrolyte may surround these layers of the jelly roll 402.

More specifically, jelly roll 402 may include a strip of positive electrode material (e.g., aluminum foil coated with a lithium-containing compound) and a strip of negative electrode material (e.g., copper foil coated with carbon) separated by a strip of separator material (e.g., conducting polymer electrolyte). In the present embodiment, the strips of positive electrode material, negative electrode material, and separator material may be wound to form a spirally wound structure. In other embodiments, strips may be configured to form other types of battery cell structures, such as bi-cell structures.

Exemplary positive electrode materials may include lithium-containing compounds such as lithium cobalt oxide (LiCoO₂), lithium nickel manganese cobalt oxide (LiNi_{1-x-y}MnₓCo_{y}O₂), lithium nickel cobalt aluminum oxide (LiNi_{0.8}Co_{0.15}Al_{0.05}O₂), lithium manganese oxide (LiMn₂O₄), lithium iron phosphste (LiFePO₄), and lithium nickel manganese oxide (LiNi_{0.5}Mn_{1.5}O₄), among other positive electrode materials. Exemplary negatice electrode materials may include carbon (e.g., graphite), silicon, and mixtures of carbon and silicon, among other negative electrode materials.

During assembly of the battery cell 400, jelly roll 402 may be enclosed in a flexible pouch, which may be formed by folding a flexible sheet along fold line 412. For example, the flexible sheet may be made of aluminum with a polymer film, such as polypropylene and/or polyethylene. After the flexible sheet is folded, the flexible sheet may be sealed, for example, by applying heat along a side seal 410 and along a terrace seal 408. The diluted concentrated electrolyte may be introduced to the flexible pouch before or after it is sealed.

Jelly roll 402 may also include a set of conductive tabs 406 coupled to the positive and negative electrodes. Conductive tabs 406 may extend through seals in the pouch (for example, formed using sealing tape 404) to provide terminals for the battery cell 400. Conductive tabs #06 may then be used to electronically couple battery cell 400 with one or more other battery cells to form a battery pack. For example, the battery pack may be formed by coupling battery cells in series, parallel, or series-and-parallel configurations.

### Exemplary Electronic Devices

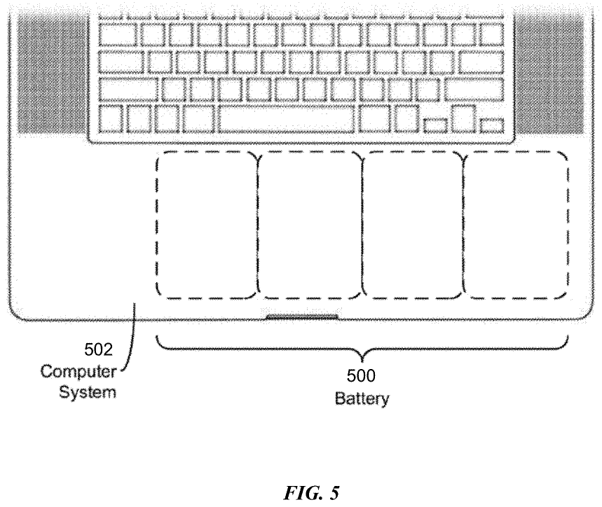

FIG. 5 shows the placement of an exemplary battery cell 500 in a computer system 502 in accordance with a present embodiment. Computer system 502 may correspond to a laptop computer, personal digital assistant (PDA), portable media player, mobile phone, digital camera, tablet computer, and/or other portable electronic device. Battery cell 500 may correspond to a lithium-ion battery for the computer system 502 that functions as a power source for computer system 502. For example, battery cell 500 may include one or more lithium-ion battery cells packaged in flexible pouches. The battery cells may then be connected in series and/or parallel and used to power computer systems 502. Each battery cell may include a positive electrode, a negative electrode, a separator, and the present diluted concentrated electrolyte.

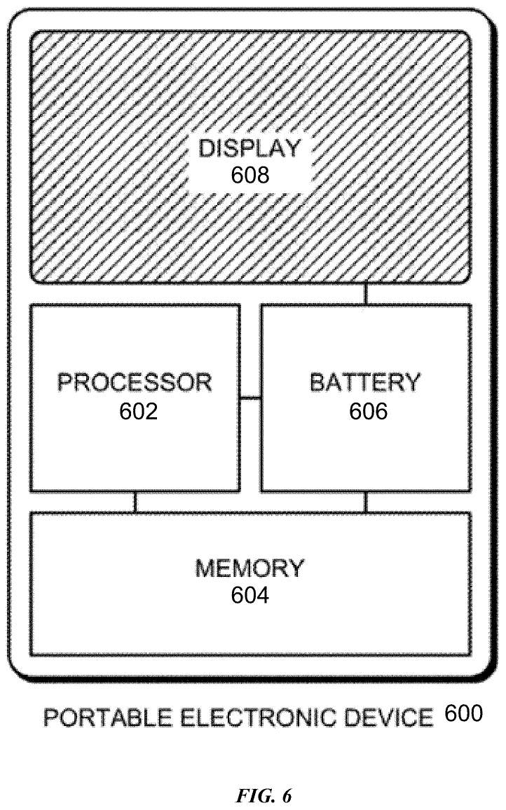

FIG. 6 shows the placement of the present battery cell 606 for powering a portable electronic device 600 that also includes a processor 602, a memory 604, and a display 608. Portable electronic device 600 may correspond to a laptop computer, mobile phone, PDA, tablet computer, portable media player, digital camera, and/or other type of battery-powered electronic device. Battery cell 606 may be incorporated into a larger battery pack that includes two or more of the battery cells. Each battery cell may include a positive electrode, a negative electrode, a separator, and the present diluted concentrated electrolyte.

### Experimental

Battery cell swelling and electrical resistance measurements were taken on lithium-ion battery cells that included the present electrolytes and compared with the same measurements on a lithium-ion battery cells that included a conventional non-aqueous electrolyte. The battery cells were essentially identical except for the electrolytes, and included a lithium-cobalt-oxide (LCO) positive electrode and graphite negative electrode.

### Battery Swelling Measurements:

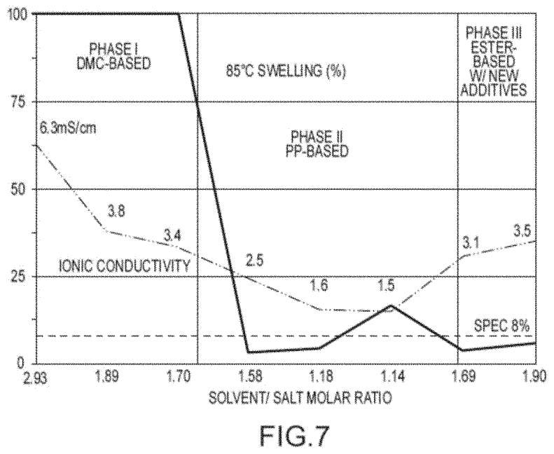

FIG. 7 is a graph that shows battery cell swelling, in terms of vol. % increase, as a function of the molar ratio of solvent to salts in the battery cell's electrolyte. The swelling measurements were taken after the battery cell was heated to a temperature of 85° C. for 8 hours. The left portion of the graph shows a large volume increase in a battery cell that included a conventional electrolyte with the lithium salts dissolved in a carbonate-containing solvent (e.g., dimethyl carbonate). The swelling of the battery cell with this electrolyte exceeded 100 vol. % until the mole ratio of the solvent to salts was less than 1.7. Even at a solvent/salt mole ratio of 1.7 the swelling in the battery cell was about 75 vol. %, which is well above a maximum recommended swelling volume of less than or about 8 vol. %.

The middle portion of the graph shows the volume increase in a battery cell that included an electrolyte with lithium salts, a non-carbonate-containing solvent (e.g., propyl propionate) and diluent. The graph shows that the swelling volume in the battery cell ranged from near 0 vol. % to about 15 vol. % until the solvent/salt ratio exceeded 1.5. This portion of the graph showed that the battery cells with electrolytes made with non-carbonate-containing solvents exhibited reduced swelling compared to the battery cells that included electrolytes made with carbonate solvents.

The right portion of the graph shows the volume increase in a battery cell that included an electrolyte that added a phosphorous-containing additive to the electrolyte in the battery cell in the middle portion of the graph. The phosphorous-containing additive had the formula:

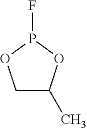

The right portion of the graph shows that the phosphorous-containing additive significantly reduced the swelling volume in the battery cell compared to the same electrolyte without the additive (i.e., the middle portion of the graph) and compared to the carbonate-containing electrolyte (i.e., the left portion of the graph). Electrolytes according to present embodiments that include the phosphorous-containing additive can reduce the swelling of a battery cell, as measured by the change in volume of the battery cell, to less than or about 10 vol. %, less than or about 9 vol. %, less than or about 8 vol. %, less than or about 7 vol. %, less than or about 6 vol. %, less than or about 5 vol. %, or less, over the operational lifetime of the battery cell.

### Battery Cell Resistance Measurements:

Battery cell resistance measurements (i.e., electrical impedance (Rₛₛ) were taken over 600 charge/discharge cycles for battery cell Samples #1-3 and Comparative Samples #1-2. Samples #1-3 were 4.47 V lithium ion battery cells that included and electrolyte having ˜2.5 M LiFSI and a solvent/Li salt mole ratio of ˜1.9. The lithium salt was dissolved in the electrolyte's liquid medium that included a solvent of propyl propionate (˜28 wt. % of electrolyte), a diluent of trifluoro toluene (˜30 wt. %), a hexane trinitrile positive-electrode additive (˜2.5 wt. %), carbonate-containing negative-electrode additives (˜6 wt. %), and a phosphorous-containing additive (˜1 wt. %). Comparative Samples #1-2 were also 4.47 V lithium-ion battery cells that included a conventional electrolyte having ˜1.5 M lithium salt dissolved in carbonate-based (e.g., dimethyl carbonate) solvent. The charge/discharge cycles of all the battery cells were conducted at elevated temperature (i.e., 45° C.) and a depth-of-discharge (DOD) of 80%.

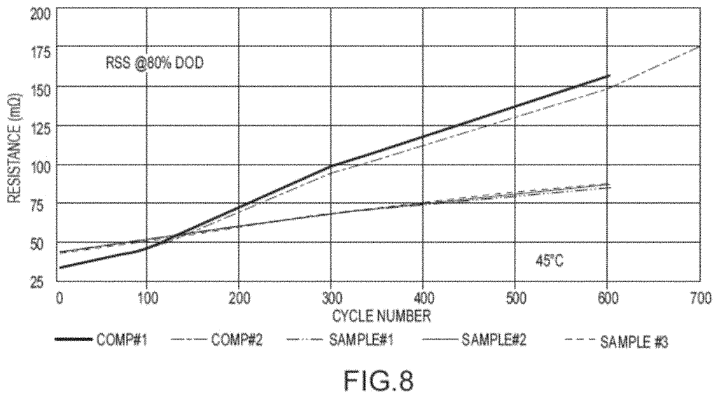

FIG. 8 is a graph showing the electrical impedance (Rₛₛ) in the battery cells of Samples #1-3 and Comparative Samples #1-2 over 600 charge/discharge cycles of the battery cells. The graph shows that Samples #1-3 had a lower rate of increase in the electrical impedance after 600 cycles, from about 40 mΩ to ˜80 mΩ, compared to the Comparative Samples #1-2, which went from about 30 mΩ to over 150 mΩ. In embodiments, the increase in electrical impedance (Rₛₛ) after 600 charge/discharge cycles of battery cell having an electrolyte according to the present embodiments may be less than or about 100%, less than or about 90%, less than or about 80%, less than or about 70%, less than or about 60%, less than or about 50%, or less. In further embodiments, the increase in electrical impedance (Rₛₛ) after 600 charge/discharge cycles of battery cell having an electrolyte according to the present embodiments may be less than or about 50 mΩ, less than or about 40 mΩ, less than or about 30 mΩ, less than or about 20 mΩ, less than or about 10 mΩ, or less.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included. Where multiple values are provided in a list, any range encompassing or based on any of those values is similarly specifically disclosed.

As used herein and in the appended claims, the singular forms “a”, “an”, and “the” include plural references unless the context clearly dictates otherwise. Thus, for example, reference to “a material” includes a plurality of such materials, and reference to “the cell” includes reference to one or more cells and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. An electrolyte for a lithium-containing battery cell, the electrolyte comprising:
a solvent comprising at least one non-carbonate-containing ester compound;
one or more lithium salts, wherein the lithium salts have a concentration of greater than or about 2 mols/liter in the electrolyte; and
a diluent comprising a fluorinated organic compound.

2. The electrolyte of claim 1, wherein the one or more lithium salts are characterized by a supersaturated concentration in the solvent.

3. The electrolyte of claim 1, wherein the at least one non-carbonate-containing ester compound comprises at least one of an alkyl propionate and an alkyl butyrate.

4. The electrolyte of claim 3, wherein the alkyl propionate comprises ethyl propionate, propyl propionate, or butyl propionate, and
wherein the alkyl butyrate comprises ethyl butyrate, propyl butyrate, or butyl butyrate.

5. The electrolyte of claim 1, wherein the one or more lithium salts comprise one or more of LiPF₆, LiAsF₆, LiBF₄, LiSbF₆, LiAlCl₄, LiClO₄, LiBrO₄, LiIO₄, LiCF₃SO₃, LiC₄F₉SO₃, LiCF₃COO, LiN(CF₃CO)₂, LiN(CF₃SO₂)₂, LiN(C₂F₅SO₂)₂, LiN(CF₃SO₂)(C₄F₉SO₂), LiC(CF₃SO₂)₃, LiN(SO₂F)₂, LiPF₄(CF₃), LiPF₄(C₂F₅), LiPF₄(CF₃SO₂)₂, LiPF₄(C₂F₅SO₂)₂, and LiBF₂(C₂F₅SO₂)₂.

6. The electrolyte of claim 1, wherein the electrolyte is characterized by a viscosity of less than or about 20 cP at 23° C.

7. The electrolyte of claim 1, wherein the diluent represents greater than or about 10 vol. % of the electrolyte.

8. The electrolyte of claim 1, wherein the electrolyte further comprises a phosphorous-containing additive that represents less than or about 2 wt. % of the electrolyte.

9. The electrolyte of claim 8, wherein the phosphorous-containing additive has the formula:

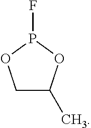

10. An electrolyte for a lithium-containing battery cell, the electrolyte comprising:
a solvent comprising at least one non-carbonate-containing ester compound;
one or more lithium salts, wherein the lithium salts have a concentration of greater than or about 2 mols/liter in the electrolyte;
a diluent comprising a fluorinated organic compound; and
a phosphorous-containing additive that represents less than or about 2 wt. % of the electrolyte,
wherein the electrolyte is characterized by a viscosity of less than or about 20 cP at 23° C.

11. The electrolyte of claim 10, wherein the at least one non-carbonate-containing ester compound comprises at least one of an alkyl propionate and an alkyl butyrate.

12. The electrolyte of claim 10, wherein the one or more lithium salts comprise one or more of LiPF₆, LiAsF₆, LiBF₄, LiSbF₆, LiAlCl₄, LiClO₄, LiBrO₄, LiIO₄, LiCF₃SO₃, LiC₄F₉SO₃, LiCF₃COO, LiN(CF₃CO)₂, LiN(CF₃SO₂)₂, LiN(C₂F₅SO₂)₂, LiN(CF₃SO₂)(C₄F₉SO₂), LiC(CF₃SO₂)₃, LiN(SO₂F)₂, LiPF₄(CF₃), LiPF₄(C₂F₅), LiPF₄(CF₃SO₂)₂, LiPF₄(C₂F₅SO₂)₂, and LiBF₂(C₂F₅SO₂)₂.

13. The electrolyte of claim 10, wherein the phosphorous-containing additive has the formula:

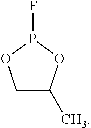

14. The electrolyte of claim 10, wherein the electrolyte comprises less than or about 5 wt. % of carbonate-containing compounds.

15. A lithium-containing battery cell comprising:
a positive electrode;
a negative electrode; and
a lithium-containing electrolyte, wherein the lithium-containing electrolyte comprises:
a solvent comprising at least one non-carbonate-containing ester compound;
at least one lithium salt having a concentration of greater than 2 mols/liter; and
a diluent comprising a fluorinated organic compound.

16. The lithium-containing battery cell of claim 15, wherein the at least one non-carbonate-containing ester compound comprises at least one of an alkyl propionate and an alkyl butyrate.

17. The lithium-containing battery cell of claim 16, wherein the lithium-containing electrolyte is characterized by a viscosity of less than or about 20 cP at 23° C.

18. The lithium-containing battery cell of claim 15, wherein the lithium-containing electrolyte comprises a phosphorous-containing additive that represents less than or about 2 wt. % of the lithium-containing electrolyte.

19. The lithium-containing battery cell of claim 15, wherein the battery cell is characterized by a swelling volume percentage of less than or about 10 vol. % after operating at 85° C. for 8 hours.

20. The lithium-containing battery cell of claim 15, wherein the battery cell is characterized by a change in battery cell impedance of less than or about 40% after greater than or about 600 charging cycles.
